(19) United States
(12) Patent Application Publication
(10) Pub. No.: US 2013/0152411 A1
(43) Pub. Date: Jun. 20, 2013

(54) METHOD FOR DETERMINING DEFECTS IN A WIND TURBINE BLADE ROOT ATTACHMENT AND MEASURING TOOL FOR CARRYING OUT SUCH METHOD

(71) Applicant: Horacio Bulacio Bossio, Barcelona (ES)

(72) Inventor: Horacio Bulacio Bossio, Barcelona (ES)

(73) Assignee: ALSTOM WIND, S.L.U., Barcelona (ES)

(21) Appl. No.: 13/813,384

(22) PCT Filed: Aug. 11, 2011
(86) PCT No.: PCT/EP2011/063828

§ 371 Date: Jan. 30, 2013

(30) Foreign Application Priority Data
Aug. 13, 2010 (EP) 10382230.0

(51) Int. Cl. G01B 11/14

(52) U.S. Cl. CPC G01B 11/14
USPC 33/228; 33/286

(57) ABSTRACT

Reference bores are selected in blade extender and one or more reference plates are provided at a height (h1; h2) from extender flange. A reference laser device is provided within reference bores which beam impinging on reference plates is in line with bore axis. A blade root bore is selected and a laser device is fitted therein such that a measuring laser beam impinging on plates is in line with axis of blade root bore. The measuring laser beam can be then assessed. A measuring tool is used having a first end to which laser devices can be attached or other devices such as a comparator, and a movable second end for being inserted within the corresponding bores with a tight fit.

The contents of PCT/EP2011/063828 are hereby incorporated by reference in its entirety for all purposes.

### TECHNICAL FIELD

A method for determining defects in a wind turbine blade root attachment is disclosed.

A measuring tool for carrying out such method of determining defects in a wind turbine blade root attachment is also disclosed.

### BACKGROUND

The blades in a wind turbine are very long members that are exposed to great stress. The blades are typically attached, at a blade root portion thereof, to a rotor hub, either directly or through a blade extender, and through a blade root attachment. Blade root attachment comprises a number of bores formed in the blade root portion and a number of bores formed in the blade extender and/or in the hub. The bores are suitable for receiving attaching studs therein for attaching the blade root to the blade extender or hub. Bushings or metallic inserts may be provided within the bores for receiving the studs.

The great stress the blades are subjected to causes a strain. Although this can be mitigated by varying the blade pitch, it has been found that studs become at least deflected but sometimes even broken at a distance from an extender surface causing a longitudinal crack in a leading edge. A visual inspection during maintenance operations usually results in that a stud and bushing deflection is detected. Deflection is typically due to an interference with the bore of the blade extender which is confirmed during a stud removal process. When the stud is removed from the bushing within the bore, scratches formed on the nut that is screwed on the stud are also detected, particularly at a half portion of a washer that is fitted therebetween. Bushing for replacing deflected and/or broken studs and bushings makes necessary the use of special tooling. It has been found however that replaced studs and bushings become broken again.

It would be therefore useful to obtain precise information on stud, and bushing, deformation. In this respect, it would be useful to obtain information on the positioning and misalignment of the bushing on the wind turbine blade root and/or the blade extender.

Methods for measuring the load acting on a wind turbine blade root portion and how this affects the blade root attachment are known in the art and they are mainly based on the use of sensors.

For example, US2006000269 discloses a method in which a first end of a beam is coupled to the rotor blade and a second end of the beam is positioned adjacent the hub. Beam deflection is then measured using at least one sensor, and blade deflection is determined based on beam deflection.

As another example, a method for measuring the deflection of an elongated member in a wind turbine is disclosed in EP2037213. This is carried out by measuring variations on the distance between two points of said elongated member through the use of, for example, a laser range sensor.

The main disadvantage of these known methods is that sensors are expensive and do not provide measurements such as in the bushing thread axis, which is indeed one of the most relevant parameters to characterize potential reliability problems in wind turbine blades. In addition, known methods can not be employed for measuring the perpendicularity of the bushing thread axis to a contact surface between the nut screwed on the stud and the wind turbine blade root.

### SUMMARY

A reliable, accurate and cost-effective method for determining defects in a wind turbine blade root attachment is disclosed as defined in claim 1 through which the above mentioned prior art problems can be overcome or at least alleviated.

A blade root attachment includes a number of spaced apart blade root bores formed in an end surface or flange of the periphery of the blade root and a number of reference bores formed in the blade extender or hub of the wind turbine rotor. Both the blade root and the reference bores are suitable for receiving attaching studs therein for attaching the blade root to the blade extender or hub through the use of corresponding nuts and washers. Bushings or metal inserts can be also provided inserted within at least some of the blade root bores. The studs can be fitted into said bushings. Bushings may have an inner threaded portion.

According to the present method, at least one attaching stud is first removed from the bore where it is fitted. If the attaching stud is fitted within a bushing in the bore, the attaching stud will be then removed from the bushing. Then, two or more reference bores are selected in the blade extender or hub. Reference bores have an inner wall that is perpendicular to an end surface or flange of the extender or hub and, in operation, is in contact with the blade root.

A number of reference plates, for example one or two, are then provided inside the blade extender or hub. One or several reference laser devices are then fitted within said selected reference bores. In this example, two reference bores have been selected so two reference laser devices are used. The reference laser devices are fitted within the reference bores of the blade extender or hub in a way that the corresponding reference laser beams are projected in line with the respective axis of the selected reference bores. Both projected reference laser beams impinge on the reference plate or plates.

Then, at least one blade root bore is selected in the blade root and a measuring laser device is fitted therein. A measuring laser beam is then projected towards the reference plate impinging thereon. The measuring laser device is fitted within the blade root bore such that the measuring laser beam is in line with the axis of the blade root bore, that is, in line with the axis of a bushing thread portion.

Then, a line is defined by the measuring laser beam impinging on the reference plate and a step is performing of assessing said line for determining defects. Said laser assessing step may include, for example, comparing the line representing the measuring laser beam with a line representing the reference laser beam and determining their relative angular deviation. However, the laser assessing step may include determining an equation of a line corresponding to the measuring laser beam. For this purpose, two or more reference plates are provided at different heights respectively from one end of the blade extender. From this line equation, deviation of the axis of the stud fitted within the blade root with regard to the reference laser beams can be assessed.

The slope of the end surface or flange of the blade extender or hub can be also assessed through the use of a comparator according to the present method.

The above mentioned measuring laser device may be carried by an adjustable measuring tool as the one defined in claim 10. This adjustable measuring stud is suitable for determining defects in a wind turbine blade root attachment and it is sized such that it can be fitted within blade root bores. The measuring tool is provided with a stem having, at a first end thereof, a laser device receiving portion and a stem. In some embodiments, the first end of the stem of the tool may be configured for receiving a comparator for measuring the slope of an end surface of the blade extender or hub.

The second, opposite end of the stem is sized such that it can be inserted within the blade root bore or within a bushing inserted therein, if provided. The second end of the stem of the measuring tool may include an adjustable portion that can be driven such that it is moved relative to the first end. The relative displacement of the second end relative to the first end results in a tight fit of the stem against the inside of the blade root bore when the tool has been inserted. Such displacement of the second end may be axial along the stem longitudinal axis or it may be radial, that is, perpendicular to the stem longitudinal axis.

The first end of the stem may have a portion protruding outwards from the reference bore when inserted. This end portion is suitable for receiving a number of labels suitable for being read by a computer. A number of labels are attached spread on the surface of this end portion of the tool stem. The number and size of the labels is such that they can be read through a suitable 3-dimensional coordinate measuring technique (photogrammetry). By means of this technique, photographs are made which are subsequently used for characterizing the longitudinal axis of the blade root bore.

By carrying out the above disclosed method and tool, a number of advantages are achieved over the prior art. For example, it is possible to reproduce the real axis of the inner thread of the bushing and to measure the perpendicularity between such axis and the end surface or flange. Therefore, it can be assessed whether imperfections give rise to extra bending loads over the stud. A good quality control of blade can be achieved, and existing problems on installed blades can be checked.

The present disclosure is not limited to applications in wind turbines but it can be also used in any applications requiring checking of the alignment of threads in mechanic joints with high loads.

### BRIEF DESCRIPTION OF THE DRAWINGS

A particular embodiment will be described in the following, only by way of non-limiting example, with reference to the appended drawings, in which:

FIG. 1 is a fragmentary perspective view of a wind turbine blade root portion attached to a wind turbine blade extender in which the main elements for performing the present method are shown;

FIG. 2 is a fragmentary perspective view of an enlarged portion of the wind turbine blade root portion attached to the wind turbine blade extender in FIG. 1

FIG. 3 is a graph diagrammatically representing a stud real axis and its orientation relative to a reference bore axis;

FIG. 4 is a sectional view of one embodiment of an adjustable measuring tool according to the present disclosure with a laser device fitted at one end thereof;

FIG. 5 is perspective view of a comparator; and

FIG. 6 is a sectional view of the comparator in FIG. 5.

### DETAILED DESCRIPTION OF PARTICULAR EMBODIMENTS

A method and a tool for determining defects in a wind turbine blade root attachment are now disclosed with reference to the drawings.

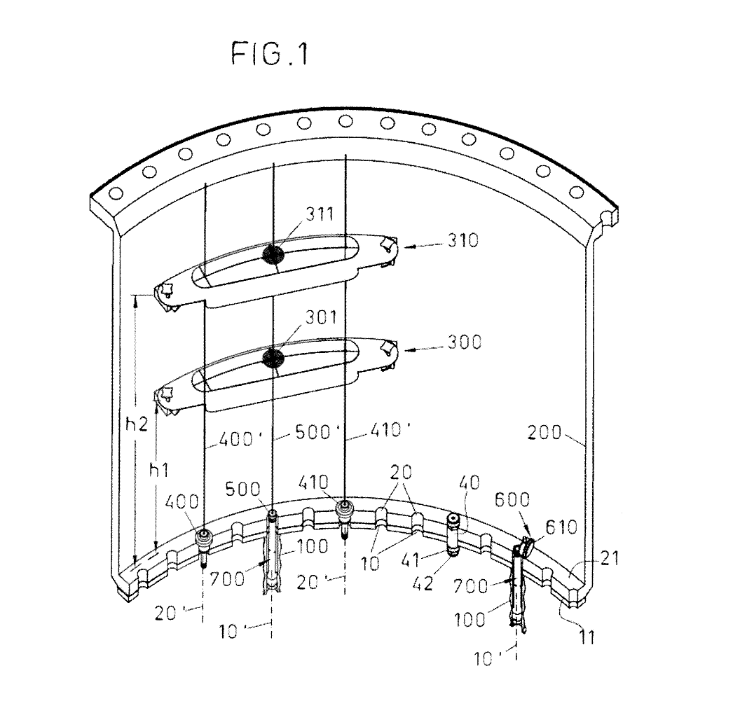

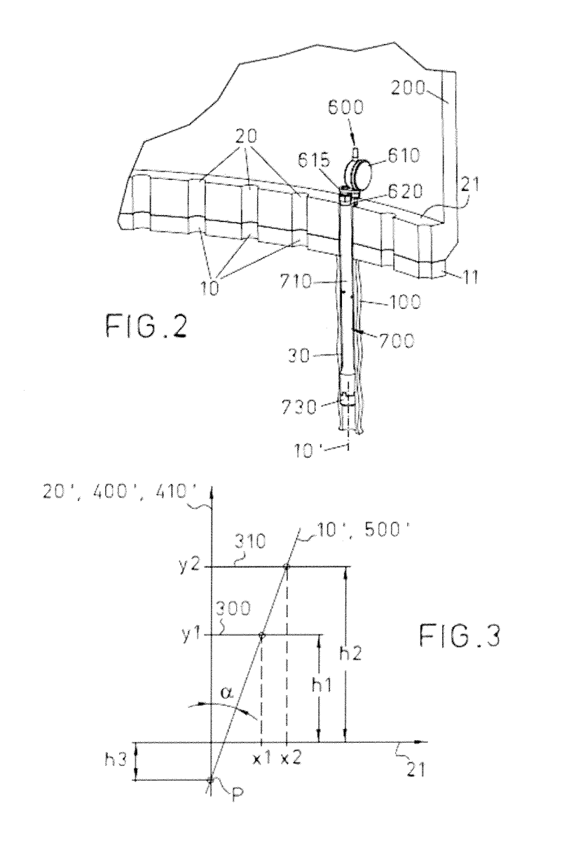

As shown in FIGS. 1 and 2, a root portion 100 of a wind turbine blade has an end surface or root flange 11. In use, the root flange 11 is attached to a rotor hub (not shown) through a blade extender 200. Blade extender 200 has an extender flange 21 too. Flanges 11 and 21 are in close contact when root portion 100 and blade extender 200 are attached to each other as shown in FIGS. 1 and 2.

The attachment of the blade root portion 100 to the blade extender 200 is carried out through a blade root attachment. The blade root attachment includes a number of blade root bores 10 and a number of reference bores 20. Blade root and reference bores 10, 20 are arranged such that they are aligned to each other as shown in FIGS. 1 and 2.

Blade root bores 10 are formed in the root flange 11 of the root portion 100, and reference bores 20 are formed in the extender flange 21 of the extender 200. It is to be understood, however, that reference bores 20 could be formed also in one end flange of the hub.

Blade root bores 10 and reference bores 20 may be provided with corresponding bushings 30 fitted therein. Bushings 30 are suitable for receiving the attaching studs 40 for coupling the blade extender 200 to the blade root 100 through the use of respective nuts 41 and washers 42.

Both the blade root and extender flanges 11, 21 are substantially perpendicular to the respective cylindrical wall of the root portion 100 and the extender 200. However, the perpendicularity of the extender flange 21 has to be measured in order to obtain more accurate information on deformation of said studs 40 and bushings 30.

For carrying out the present method, at least two reference bores 20 are first selected in the blade extender 200. Two reference plates 300, 310 are provided inside the extender 200 at different heights h1, h2 from the blade extender flange 21. As shown in FIG. 1, the reference plates 300, 310 are arranged such that h2>h1. Reference plates 300, 310 are made, for example, of methacrylate and they are provided with corresponding target indicators 301, 311.

Two reference laser devices 400, 410 are further provided, fitted within the previously selected reference bores 20. Bushings 30 may be used fitted within the reference bores 20. The reference laser devices 400, 410 are fitted in a way that their projected reference beams 400′, 410′ are in line with the corresponding axis 20′ of the selected reference bores 20, or that of the bushing 30 fitted therein (that is, the inner thread portion thereof). This is carried out by ensuring a tight fit of the laser devices 400, 410 within the reference bores 20. Reference beams 400′, 410′ projected by the reference laser devices 400, 410 impinge on the respective target indicators 301, 311 in the reference plates 300, 310 that are arranged at said two different heights h1, h2. The respective points where reference beams 400′, 410′ impinge on indicators 301, 311 allows the position of the reference beams 400′, 410′ to be accurately assessed.

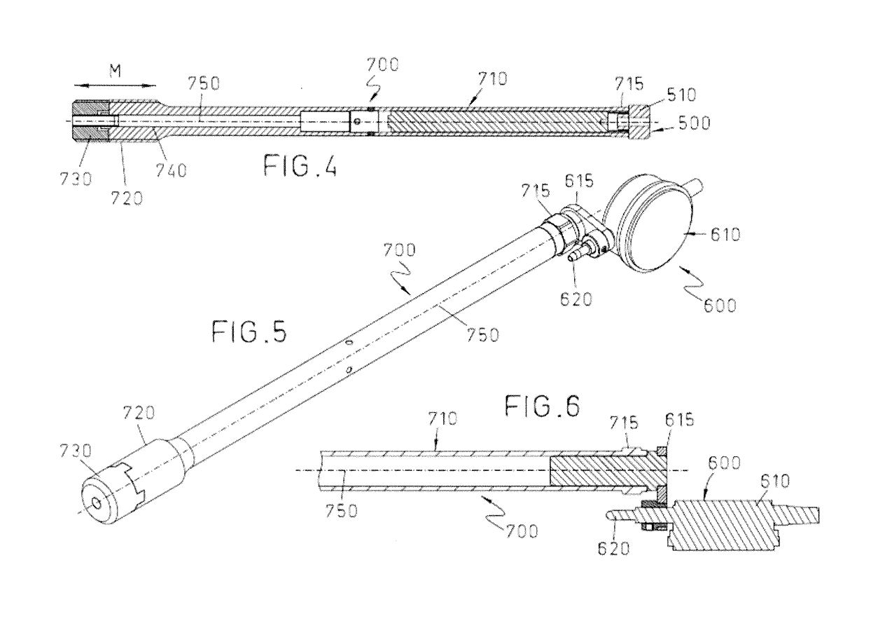

Then, a blade root bore 10 is selected for being measured. For this purpose, several attaching studs 40 are first removed from blade root and reference bores 10, 20 and a measuring laser device 500 is provided. One example of such measuring laser device 500 is shown in FIG. 4. Laser device 500 includes a laser head 510 that is fitted in a first end 715 of an adjustable measuring tool 700.

Measuring tool 700 is provided with a tool stem 710. Stem 710 has a first end 715 in which laser device 500 is attached through laser head 510. Stem 710 has a second, opposite end 720 that is configured for being inserted within the blade root bore 10 or within a threaded bushing 30 inserted therein. This second end 720 of the tool stem 710 includes an adjustable portion 730 that can be driven, for example, by means of an elongated screw (not shown) that can be rotated within an inner treaded portion 740 of the tool stem 710 around the longitudinal axis 750 of the tool 700. Rotation of the elongated screw causes the adjustable portion 730 to be displaced forward and away of the first end 715 of the tool 700 as shown by arrow M. The relative displacement between the adjustable portion 730 and the stem 710 results in a tight fit of the tool 700 against the inner wall of the blade root bore 10 where the adjustable measuring tool 700 has been inserted, or the bushing 30 fitted therein. The construction of the adjustable measuring tool 700 allows the clearance between the thread of the bushing 30 and the thread of the stud 40 to be eliminated such that a real measurement of the stud axis 10′ (or the inner threaded portion thereof) is obtained. Although the adjustable portion 730 of the tool 700 has been shown and disclosed herein as being capable of performing an axial displacement along the longitudinal axis 750 of the tool 700 according to arrow M, the adjustable portion 730 of the tool could be moved radially, i.e., perpendicular to the longitudinal axis 750 for achieving such tight fit of the tool 700 within bore 10.

The first end 715 of the tool 700 may be also configured for carrying a number of labels (not shown) suitable for being read by a computer through a photogrammetry application for characterizing the longitudinal axis 10′ of the blade root bore 10.

The first end 715 of the tool stem 710 is also configured for carrying a comparator 600 for measuring the slope of the end surface or flange 21 of the blade extender 200. One embodiment of such comparator is shown in FIGS. 5 and 6.

Continuing with the present method, the measuring laser device 500 is fitted, carried by the measuring tool 700, within the bushing 30 in the blade root bore 10. This is carried out by inserting second end 720 of the tool 700 within the selected blade root bore 10 and then driving the tool adjustable portion 730 by rotating elongated screw (not shown) within the inner treaded portion 740 of the tool stem 710 around the longitudinal axis 750 thereof. This causes the adjustable portion 730 to be moved axially away of the first tool end 715 resulting in a tight fit of the tool 700 against the inner wall of the blade root bore 10. Due to such tight fit of the tool 700 inside the blade root bore 10, the measuring beam 500′ projected by laser device 500 is in line with the axis 10′ of the blade root bore 10 or the axis of the bushing 30 fitted therein (that is, the inner thread portion thereof). As with the reference laser beams 400′, 410′, the measuring beam 500′ impinges on the reference plates 300, 310 too.

A line equation of the measuring laser beam 500′ that is projected to reference plates 300, 310 during a measurement step can be then determined. The line of the measuring laser beam 500′ corresponds to blade root bore axis 10′. This line equation therefore allows the angular deviation a of the stud axis 10′ with regard to reference laser beams 400′, 410′ to be determined. The real position of the stud axis 10′ (measuring laser beam 500′) can be accurately determined through line of axis 10′ (measuring laser beam 500′).

More particularly, from said line equation it is possible to obtain:

i) the displacement x (y=0) of the stud axis 10′ (measuring laser beam 500′),
ii) the point of rotation P (x=0), that is the intersection between the stud axis 10′ with one reference axis 400′, 410′,
iii) the position of the reference bore 20,
iv) the angular deviation a of the stud axis 10′ or measuring laser beam 500′,
v) the slope of the extender flange 21 to the inner side wall of the extender 200, through a comparator 600 such as the one shown in FIGS. 5 and 6.

For determining the angular deviation a it is not necessary to provide two reference plates 300, 310. A single reference plate would be enough for assessing the measuring laser beam 500′ for determining defects.

Comparator 600 allows the slope of the blade extender flange 21 to the side wall of the extender 200 to be accurately measured. Comparator 600 includes a gauge 610 having a follower pin 620. Comparator gauge 610 is coupled to a support plate 615 which in turn is attached to one end of adjustable measuring tool 700 shown in FIG. 4 and which will be fully disclosed below. Support plate 615 is attached by one of its ends to one end of said tool 700 while gauge 610 is rotatably received at the other end thereof. This configuration with the gauge 610 of the comparator 600 attached to the tool separated therefrom allows the gauge 610 to be rotated around the tool longitudinal axis 750. In use, the second end 720 of the tool 700 is fitted within the bushing 30 of a selected reference bore 20 such that the follower pin 620 is in contact with the top surface of the blade extender flange 21. By rotating the gauge 610 around the tool longitudinal axis 750, the slope of the blade extender flange 21 relative to axis 750, that is, to the inner side wall of the extender 200, can be measured accurately.

In one measuring step of the perpendicularity of the blade extender flange 21, and by using the above described comparator 600, an angle of slope β=0.06° representing a deviation from the perpendicular was obtained with a variation of 0.05 mm between the upper and lower portions of the extender flange 21. With such a small value, the angle of slope 13 was not considered as important in this particular case.

As diagrammatically depicted in the graph of FIG. 3, the stud real axis 10′ is a line defined by coordinate x in a horizontal axis and by coordinate y in a vertical axis. Line 10′, that is the measuring laser beam 500′, represents the theoretical position of stud 40. The origin of the coordinates is at the extender flange 21 where nuts 41 and washer 42 are supported.

According to FIG. 3, for determining the equation of line 10′, two different points y1, y2 were measured at corresponding heights h1, h2, from the extender flange 21 to the respective reference plates 300, 310. In this example, measurements were at h1=900 mm and h2=1400 mm, so y1=900 mm and y2=1400 mm. Through the use of corresponding target indicators 301, 311 in the reference plates 300, 310, deviation x1, x2 was measured at these points y1, y2 resulting in x1=8 mm and x2=6 mm.

Considering the general equation of a line y=a·x+b

The slope is:

$$a = \frac{y 2 - y 1}{x 2 - x 1} = \frac{1400 - 900}{8 - 6} = 0.004$$

Then, the y-intercept, that is, the value b at the point where y-axis is crossed by line 10′ is:

b=y−a·x=8−(0.004−1400)=2.4 mm

Form this measured value of the lateral displacement of the measured stud 40 (or bushing 30) it can be said that a failure of 2.4 mm can be formed due to the contact of the stud 40 with root flange 11.

The equation of line 10′ is therefore:

y=0.004·x+2.4

A point of rotation P is evaluated at x=0. The point of rotation P is located at the vertical axis of the graph and it is represented by height h3. Measurement according to the above values resulted in P=600 mm

The angular deviation α of line 10′ to the vertical is therefore:

$$α = {tan}^{- 1} ( \frac{x 2}{y 2 + P} ) = {tan}^{- 1} ( \frac{8}{1400 + 600} ) = 0.229$$

Having the equation of line 10′ (measuring laser beam 500′), the misalignment of the axis 10′ (or that of the bushing thread) can be assessed.

Through this equation, information on deformation in studs 40 and bushings 30 can be precisely obtained as well as accurate data on their positioning and misalignment.

1. A method for determining defects in a wind turbine blade root attachment, the blade root attachment comprising a number of blade root bores formed in a blade root portion and a number of reference bores formed in a blade extender or a hub, the blade root and reference bores being suitable for receiving attaching studs therein for attaching the blade root portion (100) to the blade extender or hub, the method comprising the steps of:
selecting at least two of said reference bores;
providing at least one reference plate from one end of the blade extender;
providing a reference laser device such that a reference laser beam is in line with an axis (20′) of the selected reference bores and impinges on said reference plates;
selecting at least one blade root bore;
providing a measuring laser device in said blade root bore such that a measuring laser beam is in line with an axis of said blade root bore and impinges on said reference plates; and
assessing the measuring laser beam for determining defects.

2. The method of claim 1, wherein said laser assessing step includes comparing a line representing the measuring laser beam with a line representing the reference laser beam and determining their relative angular deviation (α).

3. The method of claim wherein at least two reference plates are provided at different heights (h1, h2) respectively from one end of the blade extender and wherein the laser assessing step includes determining an equation of a line corresponding to the measuring laser beam.

4. The method of claim 1, wherein at east some of the blade root bores includes a bushing fitted therein.

5. The method of claim 4 wherein the bushing has an inner threaded portion.

6. The method of claim 4, wherein the measuring laser beam is in line with an axis of the bushing the bushing.

7. The method of claim 5, wherein the measuring laser beam is in line with the axis of the bushing inner threaded portion.

8. The method of claim 1, wherein each reference bore has an inner wall that is perpendicular to an end surface of the extender or hub and it is in contact with the blade root portion.

9. The method of claim 1, wherein the step of providing a measuring laser device is carried out by providing an adjustable measuring tool having the measuring laser device fitted therein, said adjustable measuring tool being configured to be fitted within said blade root bore.

10. The method of claim 1, wherein it further includes the step of measuring the slope (β) of an end surface of the blade extender or hub.

11. The method of claim 1, wherein it further includes an initial step of removing attaching studs from the blade root and reference bores in which a laser device is to be fitted.

12. A measuring tool for determining defects in a wind turbine blade root attachment comprising a stem having a first end and a second end, said second end being suitable for being inserted within a blade root or reference bore wherein the second end of the stem includes an adjustable portion suitable for being moved relative to the first end when inserted into the blade root or reference bore such that a tight fit of the tool is created against inside of the blade root or reference bore.

13. The tool of claim 12, wherein a displacement of said second end is an axial displacement along a longitudinal axis of the tool.

14. The tool of claim 12, wherein a displacement of said second end is a radial displacement, perpendicular to a longitudinal axis of the tool.

15. The tool of claim 12, wherein the first end of the stem is provided with a laser device receiving portion.

16. The tool of claim 12, wherein the first end of the stem is provided with a comparator receiving portion.

17. The tool of claim 12, wherein the first end of the stem is provided with a number of labels that can be read by a computer through a photogrammetry application for characterizing the blade root bore axis.
